(19) United States
(12) Patent Application Publication
(10) Pub. No.: US 2012/0166814 A1
(43) Pub. Date: Jun. 28, 2012

(54) MEMORY CARD, HOST DEVICE, CERTIFICATION ISSUING DEVICE, MEMORY CONTROLLER, MEMORY CHIP, METHOD OF PRODUCING MEMORY CARD, AND DATA READING AND WRITING METHOD

(75) Inventors: Takamichi Hayashi, Tokyo (JP); Hiroshi Kuno, Kanagawa (JP)

(73) Assignee: SONY CORPORATION, Tokyo (JP)

(21) Appl. No.: 13/328,068

(22) Filed: Dec. 16, 2011

(30) Foreign Application Priority Data
Dec. 27, 2010 (JP) 2010-290126

(51) Int. Cl. G06F 12/14; G06F 12/02

(52) U.S. Cl. 713/189; 711/103; 711/E12.092; 711/E12.008

(57) ABSTRACT

A memory card includes one or more memory chips that store memory quality data including a storage volume value; and a certification storing unit that stores a storage volume certification including a sum storage volume value of one or more memory chips.

### BACKGROUND

The present disclosure relates to a memory card which stores data, and a host device, a certification issuing device, a memory controller, a memory chip, a method of producing a memory card, and a data reading and writing method, which are related to the memory card.

Recently, a memory card has been frequently used as a storage medium of a mobile electronic apparatus such as a mobile phone, a mobile music player, and a digital camera. Since the memory card can be detached from the electronic apparatus, it is convenient to use the memory card, for example, it is possible to deal with a lot of data, it is possible to transmit and receive the data to and from apparatuses, and thus the memory card is necessary in the electronic apparatus.

As described above, since there is a great demand for memory cards, many producers supply many memory cards. Accordingly, memory cards with poor quality may arrive on the market. With respect to countermeasures against the decrease of quality, there are several proposals. For example, in Japanese Unexamined Patent Application Publication No. 2009-48585, an information processing device determining whether a mounted memory card is a genuine product or a counterfeit product when data is written or read. In the information processing device, when it is determined that the memory card is the counterfeit product, for example, a process of displaying a caution or prohibiting usage may be performed.

### SUMMARY

In the industry of the memory cards, a license organization of the memory card is frequently established, and the license organization allows makers to produce memory chips and memory controllers used in the memory cards. The license organization desires to keep the quality of the memory cards to a sufficient level for the purpose of spreading of the memory cards. However, in the related art, since the maker performs production and also evaluation of the memory cards, memory cards with inferior quality may be produced and may arrive on the market against the intension of the license organization. In the information processing device described in Japanese Unexamined Patent Application Publication No. 2009-48585, there is no description about a specific method of reducing concern that the memory cards with inferior quality may arrive on the market.

It is desirable to provide a memory card, a host device, a certification issuing device, a memory controller, a memory chip, a method of producing a memory card, and a data reading and writing method, capable of reducing the concern that the memory cards with inferior quality may arrive on the market.

A memory card according to an embodiment of the present disclosure includes one or more memory chips and a certification storing unit. One or more memory chips store memory quality data including a storage volume value. The certification storing unit stores a storage volume certification including a sum storage volume value of one or more memory chips.

A host device according to another embodiment of the present disclosure includes a communication unit, a reading and writing unit, and a certification verifying unit. The communication unit transmits and receives information to and from the memory card including one or more memory chips and a certification storing unit that stores a storage volume certification including a sum storage volume value of one or more memory chips. The reading and writing unit reads and writes data from and into the memory card through the communication unit. A certification verifying unit verifies the storage volume certification. The certification verifying unit accesses the memory card, acquires a card storage volume value, and allows reading and writing of data by the reading and writing unit when the card storage volume value coincides with the sum storage volume value.

A certification issuing device according to still another embodiment of the present disclosure includes a communication unit, and a certification generating unit. The communication unit transmits and receives information to and from a memory card having one or more memory chips storing memory quality data including a storage volume value and a certification storing unit storing a storage volume certification including a sum storage volume value of one or more memory chips. The certification generating unit acquires the sum storage volume value and generates the storage volume certification on the basis of the memory quality data.

A memory controller according to still another embodiment of the present disclosure includes a memory communication unit and a control unit. The memory communication unit transmits and receives information to and from one or more memory chips storing memory quality data including a storage volume value. The control unit controls reading and writing of information from and into one or more memory chips through the memory communication unit, and controls a certification storing unit storing a storage volume certification including a sum storage volume value of one or more memory chips to perform reading and writing of information. The control unit reads the memory quality data from one or more memory chips, and performs reading and writing data from and into one or more memory chips, and controls the certification storing unit to perform reading and writing of the storage volume certification.

A memory chip according to still another embodiment of the present disclosure includes a data storage area and a quality data storage area. In the data storage area, data is stored. In the quality data storage area, memory quality data including a storage volume value of the data storage area is stored.

A method of producing a memory card according to still another embodiment of the present disclosure includes writing quality data, producing a memory card, issuing a certification, and writing a certification. In the writing of the quality data, memory quality data including a storage volume value is written into one or more memory chips. In the producing of the memory card, one or more chips are assembled to produce a memory card. In the issuing of the certification, a sum storage volume value of one or more memory chips is acquired on the basis of the memory quality data to issue a storage volume certification including the sum storage volume value. In the writing of the certification, the storage volume certification is written into the memory card.

A data reading and writing method according to still another embodiment of the present disclosure includes acquiring a sum storage volume value, acquiring a card storage volume value, comparing the sum storage volume value with the card storage volume value, and reading and writing data. In the acquiring of the sum storage volume value, a storage volume certification is read from a memory card having one or more memory chips and a certification storing unit that stores a storage volume certification including a sum storage volume value of one or more memory chips, and the sum storage volume value is acquired. In the acquiring of the card storage volume value, a card storage volume value is acquired accessing the memory card. In the comparing, the sum storage volume value is compared with the card storage volume value. In the reading and writing, the data is read from and written into the memory card when the sum storage volume value coincides with the card storage volume value.

The memory card, the host device, the certification issuing device, the memory controller, the memory chip, the method of producing the memory card, the data reading and writing method according to the embodiments of the present disclosure, the storage volume certification is issued for the memory card on the basis of the memory quality data written into the memory chips by the certification issuing device, and the storage volume certification is stored in the certification storing unit of the memory card. In order to read and write the data from and into the memory card, in the host device, a card storage volume value acquired by access of the host device to the memory card is compared with the sum storage volume value of the storage volume certification, and the data is read from and written into the memory card when they coincide with each other.

The memory card according to the embodiment of the present disclosure includes, for example, a data storage area in which data is stored, and a quality data storage area in which memory quality data is stored, and it is preferable that the storage volume value is a volume value of the data storage area. It is preferable that the quality data storage area be, for example, an only-once-writable area. It is preferable that the certification storage unit be configured by an only-once-writable storage unit. For example, a digital signature representing that a license organization certifies the sum storage volume value may be added to the storage volume certification. The memory quality data may include, for example, unique identification numbers of the memory chips. The memory card may include a memory controller that controls reading and writing of information from and into one or more memory chips, and the certification storing unit may be provided in the memory controller. For example, the certification storing unit may be provided in at least one of one or more memory chips.

In the host device of the embodiment of the present disclosure, for example, a digital signature generated using a security key and representing that a license organization certifies the sum storage volume value may be added to the storage volume certification, and the certification verifying unit may verify that the sum storage volume value is certified by the license organization using an open key corresponding to the security key.

In the certification issuing device according to the embodiment of the present disclosure, for example, the certification generating unit may generate a digital signature representing that the license organization certifies the sum storage volume value using a security key, and may add the digital signature to the storage volume certification. The memory quality data may include unique identification numbers in the memory chips, the certification issuing device may further include an identification number database in which the identification numbers are accumulated, and the certification generating unit may issue the storage volume certification only when the identification numbers of one or more memory chips do not coincide with the identification numbers accumulated in the identification number database.

In the method of producing the memory card according to the embodiment of the present disclosure, for example, in the issuing of the certification, a digital signature represents that the license organization may certify the sum storage volume value using a security key is generated, and the digital signature may be added to the storage volume certification. For example, the memory quality data may include unique identification numbers in the memory chips, and in the issuing of the certification, the storage volume certification may be issued only when the identification number of one or more memory chips does not coincide with the identification number of memory chip used in the memory card produced in the past.

In the data reading and writing method according to the embodiment of the present disclosure, a digital signature generated using a security key and representing that a license organization certifies the sum storage volume value may be added to the storage volume certification, and in the acquiring of the sum storage volume value, it may be verified that the sum storage volume value is certified by the license organization using an open key corresponding to the security key.

According to the memory card, the host device, the certification issuing device, the memory controller, the memory chip, the method of producing the memory card, and the data reading and writing method of the embodiments of the present disclosure, the memory quality data is written into the memory chips, the storage volume certification is issued for the memory card on the basis of the memory quality data, and the reading and writing of the data are performed on the basis of the storage volume certification. Accordingly, it is possible to reduce the concern that the memory cards with inferior quality may arrive on the market.

### BRIEF DESCRIPTION OF THE DRAWINGS

FIG. 1 is a block diagram illustrating a memory card system according to an embodiment of the present disclosure.

FIG. 2 is a flowchart illustrating a process of producing a memory card shown in FIG. 1.

FIG. 3 is a flowchart illustrating a process of issuing a storage volume certification shown in FIG. 2.

FIG. 4 is a flowchart illustrating a case of reading and writing data from and into the memory card shown in FIG. 1.

FIG. 5 is a block diagram illustrating a memory card system according to a modified example.

FIG. 6 is a block diagram illustrating a memory card system according to another modified example.

### DETAILED DESCRIPTION OF EMBODIMENTS

Hereinafter, embodiments of the present disclosure will be described in detail with reference to the drawings.

### Example of Configuration

### Example of Overall Configuration

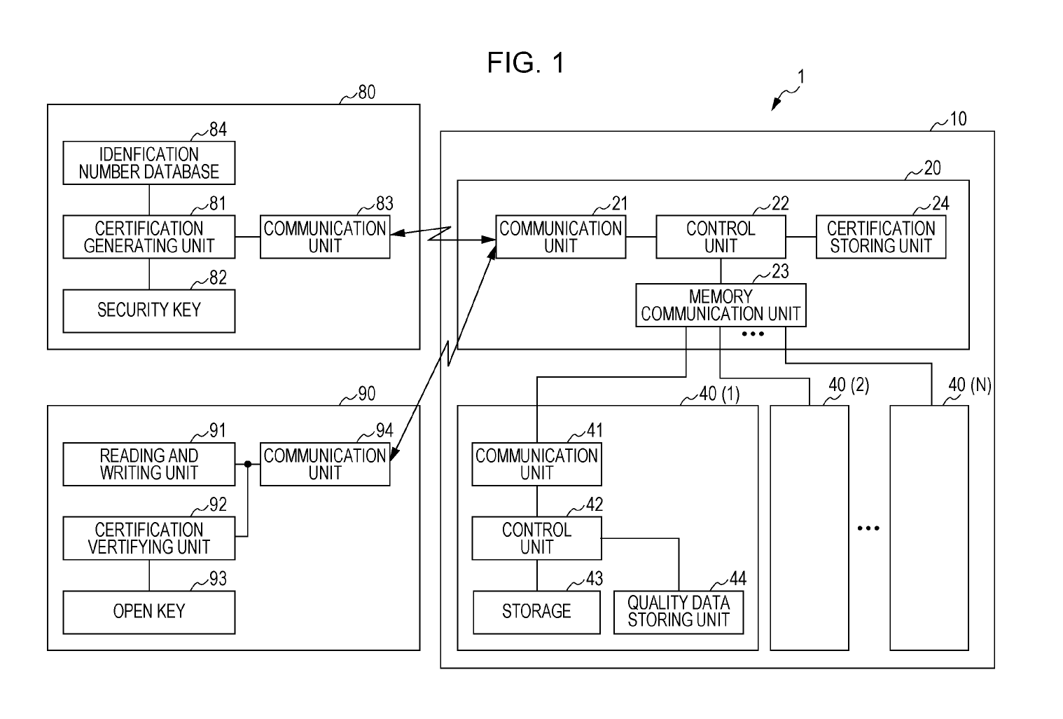

FIG. 1 is a diagram illustrating a first configuration example of a memory card system according to an embodiment of the present disclosure. A memory card system 1 uses a memory card configured by a flash memory. A host device, a certification issuing device, a memory controller, a memory chip, a method of producing a memory card, and a data reading and writing method according to the embodiments of the present disclosure are embodied by the embodiments, and they will be described together. The memory card system 1 is provided with a memory card 10, a certification issuing device 80, and a host device 90.

Memory Card 10

The memory card 10 is a storage medium storing data, and is provided with a memory controller 20, and N memory chips 40(1) to 40(N). In the following description, a memory chip 40 is appropriately used as the general term of the memory chips 40(1) to 40(N).

The memory controller 20 controls reading and writing of data from and into the memory chips 40(1) to 40(N). As will be described later, the memory controller 20 controls reading of memory quality data Q from a quality data storing unit 44 (to be described later) of the memory chips 40(1) to 40(N), and has a function of reading and writing of a storage volume certification P from and to a certification storing unit 24 (to be described later). The memory controller 20 is provided with a communication unit 21, a memory communication unit 23, a certification storing unit 24, and a control unit 22.

The communication unit 21 is an interface for the certification issuing device 80 and the host device 90. The memory communication unit 23 is an interface for the memory chips 40(1) to 40(N).

The certification storing unit 24 stores the storage volume certification P, and is configured using, for example, a programmable ROM (Read Only Memory).

The storage volume certification P certifies a total sum (sum storage volume value TS) of a storage volume value S of storages 43 of the memory chips 40(1) to 40(N) to be described later. As will be described later, the storage volume certification P is generated by the certification issuing device 80. A digital signature of a license organization of the memory card is added to the storage volume certification P, and thus the sum storage volume value TS represented in the storage volume certification P represents that the license organization certifies that the sum storage volume value is right.

It is preferable that the certification storing unit 24 may not rewrite the storage volume certification P after writing the storage volume certification P. In this case, the programmable ROM is preferably an only-once-writable memory (an OTP (One Time Programmable) memory), but is not limited thereto. It may be configured not to access the memory except for the necessary time, using a memory such as a flash memory instead of that.

The control unit 22 has a function of controlling transmission and reception of information (data and memory quality data Q) between the certification issuing device 80 and host device 90 and the memory chips 40(1) to 40(N) and controlling reading and writing of the storage volume certification P from and into the certification storing unit 24, according to an instruction from the certification issuing device 80 and the host device 90.

The memory chips 40(1) to 40(N) store the data. The memory chips 40(1) to 40(N) may store the memory quality data Q. The memory chips 40(1) to 40(N) are provided with a communication unit 41, a storage 43, a quality data storing unit 44, and a control unit 42.

The communication unit 41 is an interface for the memory controller 20. The storage 43 stores the data, and is configured by a flash memory that is an updatable and nonvolatile memory in this example.

The quality data storing unit 44 stores the memory quality data Q, and is configured using, for example, a programmable ROM.

The memory quality data Q represents quality of the memory chips 40(1) to 40(N), and includes storage volume values S and the memory chip identification numbers ID of the storages 43 of the memory chips. The memory chip identification numbers ID are unique among the memories. The memory quality data Q is generated when a producer produces and evaluates the memory chips 40(1) to 40(N), and is written into the quality data storing unit 44. That is, the storage volume value S and the memory chip identification number ID represented in the memory quality data Q are certified by the producer of the memory chips. In this example, the producer of the memory chips makes the memory quality data Q not to be stored in the quality data storing unit 44 of inferior memory chips. The present disclosure is not limited thereto, and the memory quality data Q representing that the memory is an inferior product may be written into the quality data storing unit 44.

It is preferable that the quality data storing unit 44 may not rewrite the memory quality data Q after writing the memory quality data Q similarly to the certification storing unit 24 described above. In this case, the programmable ROM is preferably the OTP memory, but is not limited thereto. It may be configured not to access the memory except for the necessary time, using a memory such as a flash memory instead of that.

The control unit 42 has a function of controlling transmission and reception of the data between the memory controller 20 and the storage 43 and controlling reading of the memory quality data Q from the quality data storing unit 44, according to an instruction from the memory controller 20.

Certification Issuing Device 80

The certification issuing device 80 issues the storage volume certification P for certifying the sum storage volume value TS of the memory card 10. For example, the license organization of the memory card supplies the certification issuing device 80 to the producer of the memory cards. The certification issuing device 80 is provided with a communication unit 83, an identification number database 84, and a certification generating unit 81.

The communication unit 83 is an interface for the memory card 10.

In the identification number database 84, the memory chip identification numbers ID of the memory chips 40 related to the memory card 10 produced in the past are stored.

The certification generating unit 81 generates the storage volume certification P. Specifically, as will be described later, first, the certification generating unit 81 acquires the memory quality data Q of the memory chips 40(1) to 40(N) from the memory card 10, confirms whether or not the memory chip identification number ID represented in the memory quality data Q coincides with the memory chip identification number ID of the memory chip 40 related to the memory card 10 produced in the past by searching the identification number database 84. The certification generating unit 81 acquires the sum storage volume value TS on the basis of the storage volume value S represented in the memory quality data Q, and generates the storage volume certification P including the sum storage volume value TS. In this case, the certification generating unit 81 generates a digital signature using a security key 82 and adds the digital signature to the storage volume certification P. The security key 82 is supplied by the license organization of the memory card, and certifies a generation source (license organization) of the storage volume certification P by the digital signature. The certification generating unit 81 transmits the storage volume certification P to which the digital signature is added, to the memory card 10 through the communication unit 83. In the memory card 10, the storage volume certification P to which the digital signature is added is written into the certification storing unit 24.

As described above, the certification issuing device 80 issues the storage volume certification P for the memory card 10, and the memory card 10 stores the storage volume certification P. The memory card 10 into which the storage volume certification P is written arrives on the market and is used for the user.

Host Device 90

The host device 90 is a so-called memory card reader/writer reading and writing the data from and into the memory card 10. The host device 90 is provided with a communication unit 94, a reading and writing unit 91, and a certification verifying unit 92.

The communication unit 94 is an interface for the memory card 10. The reading and writing unit 91 reads and writes the data from and into the memory card 10 through the communication unit 94.

The certification verifying unit 91 verifies the storage volume certification P. Specifically, as will be described later, the certification verifying unit 91 acquires the storage volume certification P from the memory card 10, and confirms whether or not the storage volume certification P is certified by the license organization by verifying the digital signature added to the storage volume certification P using an open key 93 corresponding to the security key 82 described above. The certification verifying unit 92 accesses the memory card 10 to acquire the card storage volume value of the memory card 10, and confirms whether or not the card storage volume value coincides with the sum storage volume value TS represented in the storage volume certification P. The reading and writing unit 91 can read and write the data from and into the memory card 10 when the certification verifying unit 92 confirms the coincidence.

Herein, the certification storing unit 24 corresponds to a specific example of the “certification storing unit” in the present disclosure. The storage 43 corresponds to a specific example of the “data storage area” in the present disclosure. The quality data storing unit 44 corresponds to a specific example of the “quality data storage area” in the present disclosure. The memory chip identification number ID corresponds to a specific example of the “identification number” in the present disclosure.

Operation and Effect

Subsequently, an operation and an effect of the memory card system 1 according to the embodiment will be described.

Overall Operation Outline

First, an overall operation outline of the memory card system 1 will be described with reference to FIG. 1. In the memory card system 1, first, the certification issuing device 80 issues the storage volume certification P for the memory card 10. In the memory card 10 into which the storage volume certification P is written, the user reads and writes the data using the host device 90.

To issue the storage volume certification P, first, the certification issuing device 80 acquires the memory quality data Q stored in the quality data storing unit 44 of the memory chips 40(1) to 40(N) of the memory card 10. The certification generating unit 81 confirms whether or not the memory chip identification numbers ID of the memory chips 40(1) to 40(N) coincide with the memory chip identification numbers ID of the memory chips 40 related to the memory card 10 produced in the past by searching the identification number database 84, on the basis of the memory quality data Q. The certification generating unit 81 acquires the sum storage volume value TS on the basis of the memory quality data Q, generates the storage volume certification P, adds the digital signature generated by the security key 82 to the storage volume certification P, and transmits the storage volume certification P to the memory card 10 through the communication unit 83. In the memory card 10, the control unit 22 acquires the storage volume certification P through the communication unit 21, and writes the storage volume certification P into the certification storing unit 24. The memory card 10 into which the storage volume certification P is written arrives on the market.

To read and write the data, first, the host device 90 acquires the storage volume certification P stored in the certification storing unit 24 of the memory card 10. The certification verifying unit 92 verifies the storage volume certification P using an open key 93, then acquires the card storage volume value of the memory card 10, and confirms whether or not the card storage volume value coincides with the sum storage volume value TS represented in the storage volume certification P. The reading and writing unit 91 reads and writes the data from and into the memory card 10 when the certification verifying unit 92 confirms the coincidence.

Production Process and Specific Operation

Next, a process of producing the memory card 10 and a specific operation of the memory card system 1 will be described with reference to flowcharts.

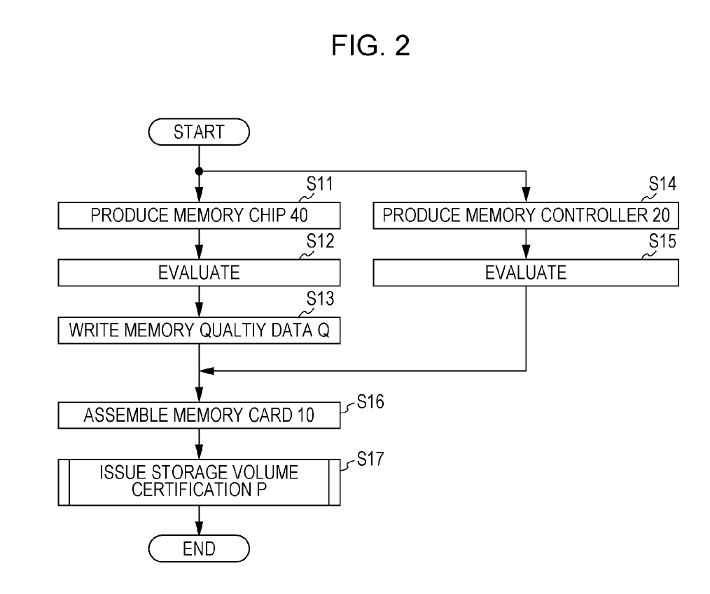

FIG. 2 shows a flowchart of the process of producing the memory card 10. In this example, the producer separately produces the memory chips 40 and the memory controller 20, then assembles them into the memory card 10, and issues the storage volume certification P for the memory card 10. Hereinafter, the details thereof will be described.

First, the producer of the memory chips 40 produces the memory chips 40 (Step S11), and evaluates whether or not the memory chips 40 are normally operated (Step S12). In this example, the producer of the memory chips writes the memory quality data Q including the storage volume value S and the memory chip identification number ID into the quality data storing unit 44 in the memory chip confirmed as being normally operated (Step S13).

The producer of the memory controller 20 produces the memory controller 20 (Step S14), and evaluates the memory controller 20 (Step S15).

Then, the producer of the memory card 10 assembles the memory chips 40 into which the memory quality data Q is written and the memory controller 20, into the memory card 10 (Step S16).

Then, the producer of the memory card 10 issues the storage volume certification P for the memory card 10 as will be described later in detail (Step S17).

The production of the memory card 10 is ended as described above.

Then, a process of issuing the storage volume certification P shown in Step S17 of FIG. 2 will be described in detail.

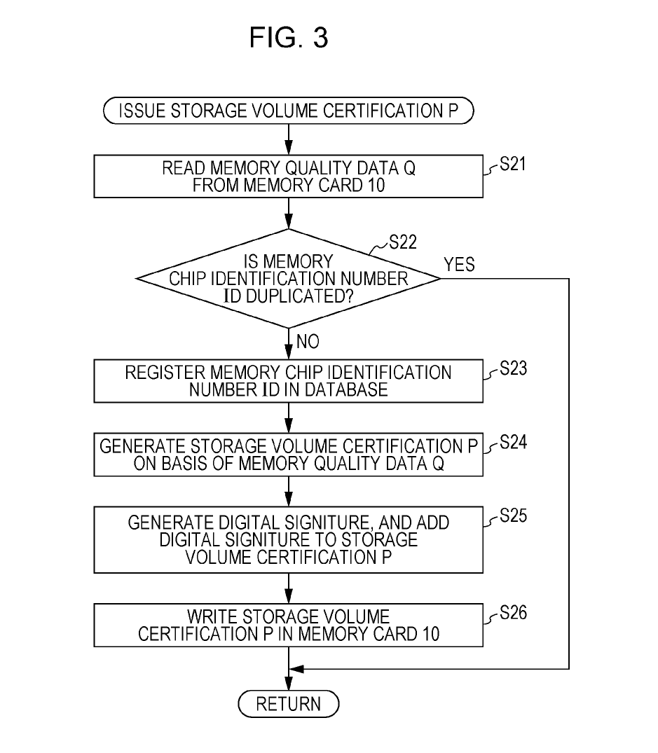

FIG. 3 is a flowchart illustrating the process of issuing the storage volume certification P for the memory card 10. In the memory card system 1, the certification issuing device 80 acquires the sum storage volume value TS of the entire memory card 10 on the basis of the memory quality data Q and issues the storage volume certification P. Hereinafter, details thereof will be described.

First, the certification issuing device 80 reads the memory quality data Q from the memory card 10 (Step S21). Specifically, first, the certification issuing device 80 acquires the memory quality data Q for the memory card 10. In the memory card 10, the control unit 22 of the memory controller 20 acquires the memory quality data Q for the memory chips 40(1) to 40(N) through the memory communication unit 23. The control unit 42 of the memory chips 40(1) to 40(N) individually reads the memory quality data Q from the quality data storing unit 44, and transmits the memory quality data Q to the memory controller 20 through the communication unit 41. The control unit 22 of the memory controller 20 transmits the plurality of memory quality data Q received from the memory chips 40(1) to 40(N) through the communication unit 23, to the certification issuing device 80 through the communication unit 21. The certification issuing device 80 acquires the memory quality data Q.

Then, the certification generating unit 81 performs coincidence check of the memory chip identification numbers ID included in the memory quality data Q acquired in Step S21 (Step S22). Specifically, the certification generating unit 81 determines whether or not the memory chip identification number ID coincides with the memory chip identification number ID of the memory chip 40 related to the memory card 10 produced in the past by searching the identification number database 84. When the memory chip identification number ID does not coincide, the process proceeds to Step S23. When the memory chip identification number ID coincides, the flow is ended. That is, when the memory chip identification number ID coincides, the storage volume certification P is not issued for the memory card 10. Accordingly, the storage volume certification P is not written into the memory card 10. Therefore, as will be described later, the host device 90 may not read and write the data from and into the memory card 10.

Then, the certification generating unit 81 registers the memory chip identification number ID in the database (Step S23). Specifically, the certification generating unit 81 registers the memory chip identification number ID of the memory quality data Q acquired in Step S21, in the identification number database 84, to update the database.

Then, the certification generating unit 81 generates the storage volume certification P on the basis of the memory quality data Q (Step S24). Specifically, the certification generating unit 81 acquires the total sum of the memory storage volume values S of the memory chips represented by the memory quality data Q of the memory chips 40(1) to 40(N) to obtain the sum storage volume value TS of the memory card 10. The certification generating unit 81 generates the storage volume certification P using the sum storage volume value TS.

Then, the certification generating unit 81 generates a digital signature and adds the digital signature to the storage volume certification (Step S25). Specifically, the certification generating unit 81 generates the digital signature using the security key 82. The certification generating unit 81 adds the digital signature to the storage volume certification P generated in Step S24.

Next, the certification issuing device 80 writes the storage volume certification P into the memory card 10 (Step S26). Specifically, the certification issuing device 80 transmits the storage volume certification P to which the digital signature is added in Step S25, to the memory card 10. In the memory card 10, the control unit 22 acquires the storage volume certification P to which the digital signature is added, through the communication unit 21, and writes the storage volume certification P into the certification storing unit 24.

The issuing of the storage volume certification P is ended as described above.

Then, a specific operation when the host device 90 reads and writes the data from and into the memory card 10 will be described.

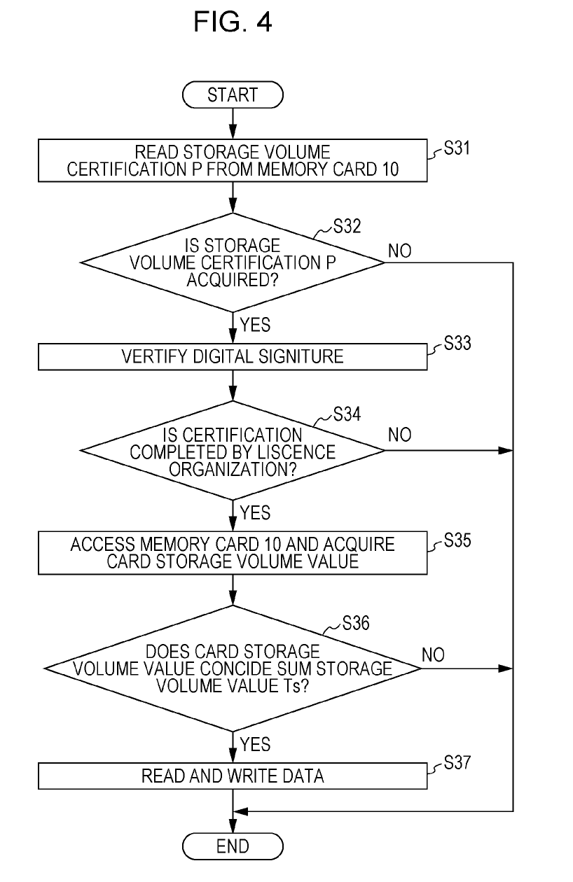

FIG. 4 is a flowchart illustrating a case of reading and writing the data. In the memory card system 1, the host device 90 reads and writes the data when it is confirmed that the memory card 10 is normal through a predetermined sequence. Hereinafter, details thereof will be described.

First, the host device 90 reads the storage volume certification P from the memory card 10 (Step S31). Specifically, first, the host device 90 acquires the storage volume certification P for the memory card 10. In the memory card 10, the control unit 22 of the memory controller 20 reads the storage volume certification P from the certification storing unit 24, and transmits the storage volume certification P to the host device 90 through the communication unit 21. The host device 90 acquires the storage volume certification P. The host device 90 confirms whether or not the storage volume certification P is acquired (Step S32). When the storage volume certification P is acquired, the process proceeds to Step S33. When the storage volume certification P is not acquired, the flow is ended. That is, in this case, the data is read from and written into the memory card 10.

Then, the host device 90 verifies the digital signature (Step S33). Specifically, the host device 90 verifies the digital signature added to the storage volume certification P using the open key 93. The host device 90 confirms whether or not the storage volume certification P is certified by the license organization (Step S34). When it is confirmed that the storage volume certification P is certified by the license organization, the process proceeds to Step S35. When it is confirmed that the storage volume certification P is certified by the license organization, the flow is ended. That is, in this case, the data is not read from and written into the memory card 10.

Then, the host device 90 accesses the memory card 10 and acquires the card storage volume value (Step S35), and confirms whether or not the card storage volume value coincides with the sum storage volume value TS represented by the storage volume certification P acquired in Step S31 (Step S36). When the card storage volume value coincides with the sum storage volume value TS, the process proceeds to Step S37. When the card storage volume value does not coincide with the sum storage volume value TS, the flow is ended. That is, in this case, the data is not read from and written into the memory card 10.

The host device 90 reads and writes the data from and to the memory card 10 (Step S37).

The flow is ended as described above.

As described above, in the memory card system 1, the memory chips 40(1) to 40(N) are provided with the quality data storing unit 44, the memory producer writes the memory quality data Q including the storage volume values S and the memory chip identification numbers ID of the memory chips into the quality data storing unit 44. That is, the storage volume values S and the memory chip identification numbers ID are certified by the producer of the memory chips. In the memory card system 1, the memory card 10 is provided with the certification storing unit 24. The producer of the memory card acquires the sum storage volume value TS of the memory card 10 using the certification issuing device 80 supplied by the license organization on the basis of the storage volume value S of the memory quality data Q, and writes the storage volume certification P including the sum storage volume value TS into the certification storing unit 24. That is, the sum storage volume value TS is acquired using a method determined by the license organization on the basis of the storage volume S certified by the producer of the memory chips, and may be considered as being certified by both of the producer of the memory chip and the license organization. Accordingly, for example, even when the memory card is provided using an inferior memory which is erroneously produced by the producer of the memory card, the using of the inferior memory is reflected to the sum storage volume value TS represented by the storage volume certification P. Accordingly, it is possible to easily determine whether or not the memory card 10 is an inferior product using the storage volume certification P.

In the memory card system 1, it is determined whether or not the memory chip identification number ID coincides with the memory number ID of the memory chip 40 related to the memory card 10 produced in the past. When the memory chip identification number ID does not coincide, the storage volume certification P is issued. Accordingly, for example, since it is possible to prevent the satisfactory product used in the production of the memory card 10 in the past from being intentionally reused, it is possible to reduce the concern that the memory cards with low quality arrive on the market.

In the memory card system 1, the host device 90 itself actually accesses the memory card 10 to acquire the card storage volume value. Only when the card storage volume value coincides with the sum storage volume value TS of the storage volume certification P, is it possible to read and write the data from and into the memory card 10. Accordingly, the user can perform reading and writing of the data only on the satisfactory memory card 10. The host device 90 can easily determine that the memory card 10 is an inferior product.

As described above, since it is possible to easily determine whether or not the memory card 10 is the inferior product by restraint in the production of the memory card with low quality by the producer, and it is possible to reduce the concern that the memory card with inferior quality will arrive on the market.

Advantage

In the embodiment as described above, the memory is provided with the quality data storing unit, the producer of the memory chip writes the quality data, and thus it is possible to clearly perform quality warranty at a memory level.

In the embodiment, the quality data storing unit does not update the memory quality data after the quality data storing unit writes the memory quality data, and thus it is possible to prevent the storage volume certification from being manipulated.

In the embodiment, the storage volume certification is issued when the memory chip identification number is not recorded in the memory chip identification number database using the certification issuing device supplied by the license organization, and thus it is possible to reduce the concern that the memory cards with inferior quality will arrive on the market.

In the embodiment, the sum storage volume value of the memory card is acquired on the basis of the memory quality data using the certification issuing device supplied by the license organization, it is possible to consider that the sum storage volume value is certified by both of the producer of the memory chip and the license organization, and thus it is possible to clarify the source of the sum storage volume value.

In the embodiment, the digital signature is added to the storage volume certification using the certification issuing device supplied by the license organization, it is possible to prevent the storage volume certification from being manipulated, and thus it is possible to further clarify the source of the sum storage volume value.

In the embodiment, the memory card is provided with the certification storing unit, the storage volume certification including the sum storage volume value is written into the certification storing unit, and thus it is possible to simply acquire the sum storage volume value considered as being certified by both of the producer of the memory chip and the license organization using the memory card itself.

In the embodiment, the certification storing unit does not rewrite the storage volume certification after the certification storing unit writes the storage volume certification, and thus it is possible to prevent the storage volume certification from being manipulated.

In the embodiment, when the host device reads and writes the data from and into the memory card, the data is read and written only when the storage volume certification to which the digital signature is added is acquired, and thus it is possible to perform the reading and writing only on the satisfactory memory card.

In the embodiment, when the host device reads and writes the data from and into the memory card, the host device accesses the memory card to acquire the card storage volume value, the card storage volume value is compared with the sum storage volume value of the storage volume certification, and thus it is possible to perform the reading and writing of the data only on the satisfactory memory card.

### Modified Example

In the embodiment, the memory controller 20 is provided with the certification storing unit 24, but is not limited thereto. Hereinafter, several examples will be described.

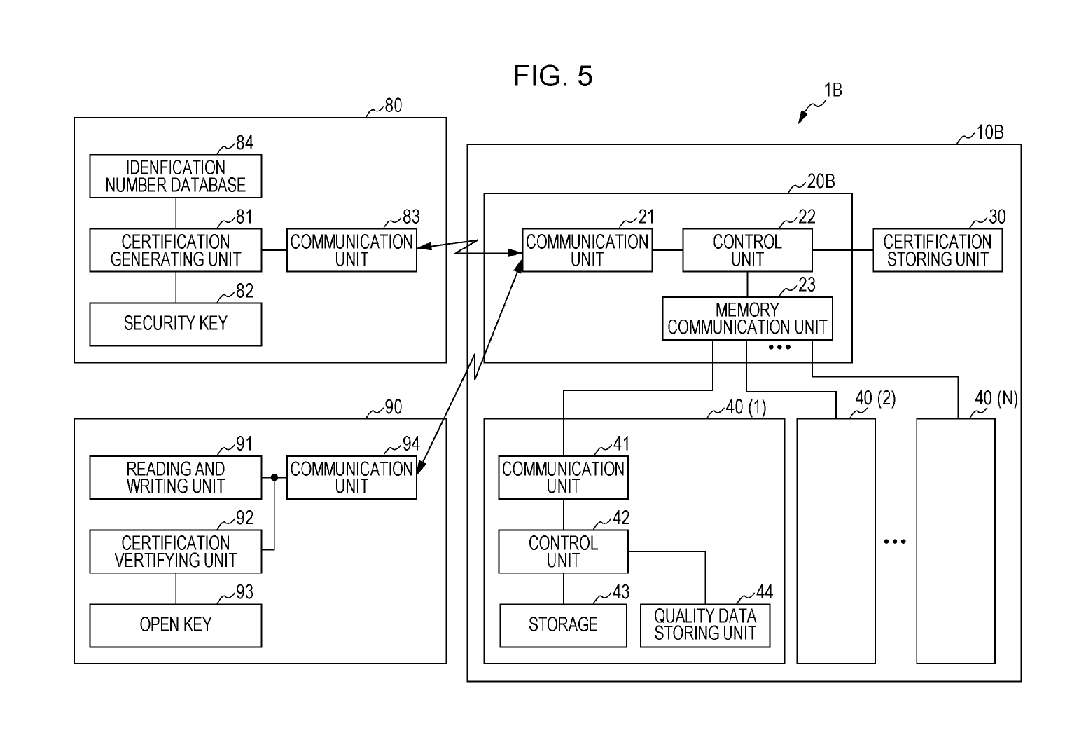

FIG. 5 shows an example of a configuration of a memory card system 1B when a certification storing unit is provided separately from a memory controller. The memory card system 1B is provided with a memory card 10B, and the memory card 10B is provided with a memory controller 20B and a certification storing unit 30. The memory controller 20B is not provided with the certification providing unit. That is, the certification storing unit 30 is provided separately from the memory controller 20B.

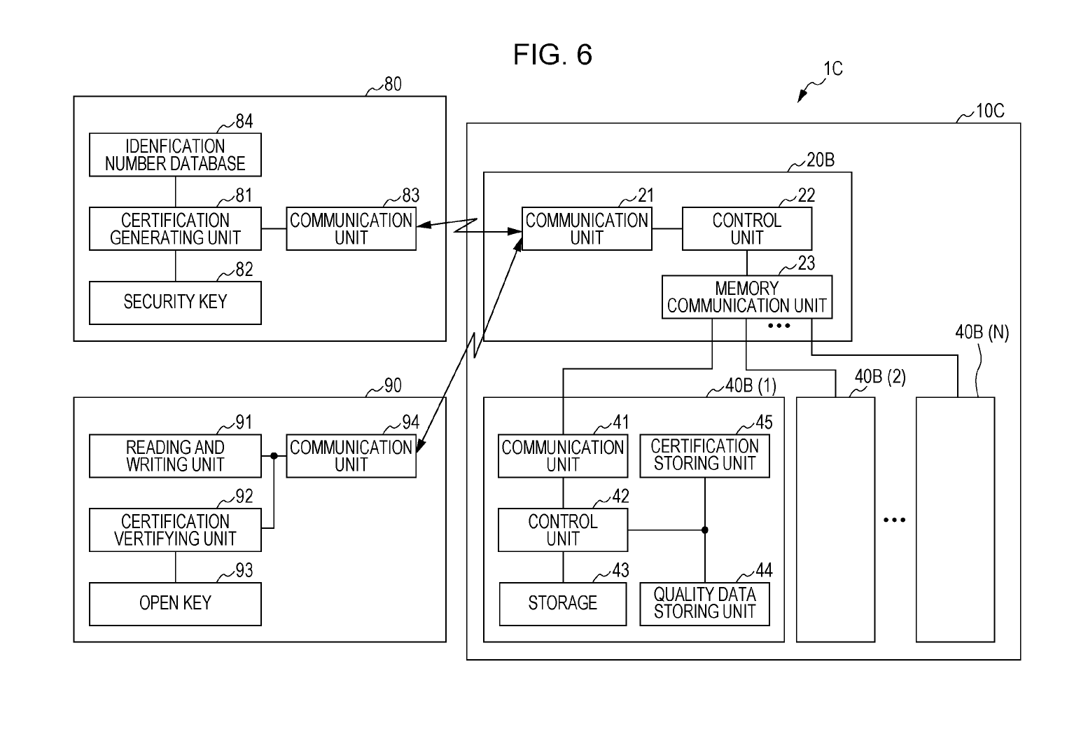

FIG. 6 shows an example of a configuration of a memory card system 1C when the certification storing unit is provided in the memory chip. The memory card system 1C is provided with a memory controller 20B, and a memory card 10C, and the memory card 10C is provided with N memory chips 40B(1) to 40B(N). Each of the memory chips 40B(1) to 40B(N) is provided with a certification storing unit 45. When the storage volume certification P is written into the certification storing unit 45, the memory controller 20B may write the storage volume certification P into the certification storing unit 45 of, for example, one memory chip 40B of the memory chips 40B(1) to 40B(N).

The present disclosure has been described above with reference to the embodiments and modified examples, but the present disclosure is not limited to the embodiments and the like, and may be variously modified.

For example, in the embodiments and the like, the storage 43 is configured by the flash memory, but is not limited thereto. For example, any of data writable storage mediums such as an HDD (Hard Disk Drive) may be used.

For example, in the embodiments and the like, the memory card 10 is provided with the plurality of memory chips 40(1) to 40(N), but is not limited thereto, and may be provided with only one memory chip 40.

The present disclosure contains subject matter related to that disclosed in Japanese Priority Patent Application JP 2010-290126 filed in the Japan Patent Office on Dec. 27, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A memory card comprising:
one or more memory chips that store memory quality data including a storage volume value; and
a certification storing unit that stores a storage volume certification including a sum storage volume value of one or more memory chips.

2. The memory card according to claim 1, wherein the memory chip includes a data storage area in which data is stored, a quality data storage area in which the memory quality data is stored, and wherein the memory volume value is a volume value of the data storage area.

3. The memory card according to claim 2, wherein the quality data storage area is an only-once-writable area.

4. The memory card according to claim 1, where the certification storing unit is configured by an only-once-writable storage unit.

5. The memory card according to claim 1, wherein a digital signature representing that a license organization certifies the sum storage volume value is added to the storage volume certification.

6. The memory card according to claim 1, wherein the memory quality data includes unique identification numbers of the memory chips.

7. The memory card according to claim 1, further comprises a memory controller that controls reading and writing of information from and into one or more memory chips,
wherein the certification storing unit is provided in the memory controller.

8. The memory card according to claim 1, wherein the certification storing unit is provided in at least one of one or more memory chips.

9. A host device comprising:
a communication unit that transmits and receives information to and from a memory card having one or more memory chips and a certification storing unit storing a storage volume certification including a sum storage volume value of one or more memory chips;
a reading and writing unit that reads and writes data from and into the memory card through the communication unit; and
a certification verifying unit that verifies the storage volume certification,
wherein the certification verifying unit accesses the memory card, acquires a card storage volume value, and allows reading and writing of data by the reading and writing unit when the card storage volume value coincides with the sum storage volume value.

10. The host device according to claim 9, wherein a digital signature generated using a security key and representing that a license organization certifies the sum storage volume value is added to the storage volume certification, and
wherein the certification verifying unit verifies that the sum storage volume value is certified by the license organization using an open key corresponding to the security key.

11. A certification issuing device comprising:
a communication unit that transmits and receives information to and from a memory card having one or more memory chips storing memory quality data including a storage volume value and a certification storing unit storing a storage volume certification including a sum storage volume value of one or more memory chips; and
a certification generating unit that acquires the sum storage volume value and generates the storage volume certification on the basis of the memory quality data.

12. The certification issuing device according to claim 11, wherein the certification generating unit generates a digital signature representing that the license organization certifies the sum storage volume value using a security key, and adds the digital signature to the storage volume certification.

13. The certification issuing device according to claim 11, further including an identification number database in which the identification numbers are accumulated,
wherein the memory quality data includes unique identification numbers in the memory chips, and
wherein the certification generating unit issues the storage volume certification only when the identification numbers of one or more memory chips do not coincide with the identification numbers accumulated in the identification number database.

14. A memory controller comprising:
a memory communication unit that transmits and receives information to and from one or more memory chips storing memory quality data including a storage volume value; and
a control unit that controls reading and writing of information from and into one or more memory chips through the memory communication unit, and controls reading and writing of information from and into a certification storing unit storing a storage volume certification including a sum storage volume value of one or more memory chips,
wherein the control unit reads the memory quality data from one or more memory chips, and reading and writing data from and into one or more memory chips, and controls the certification storing unit to perform reading and writing of the storage volume certification.

15. A memory chip comprising:
a data storage area in which data is stored; and
a quality data storage area in which memory quality data including a storage volume value of the data storage area is stored.

16. A method of producing a memory card comprising:
writing memory quality data including a storage volume value in one or more memory chips;
assembling one or more memory chips to produce a memory card;
acquiring a sum storage volume value of one or more memory chips on the basis of the memory quality data to issue a store volume certification including the sum storage volume value; and
writing the storage volume certification in the memory card.

17. The method of producing a memory card according to claim 16, wherein in the issuing of the certification, a digital signature representing that the license organization certifies the sum storage volume value using a security key is generated, and the digital signature is added to the storage volume certification.

18. The method of producing a memory card according to claim 16, wherein the memory quality data includes unique identification numbers in the memory chips,
wherein in the issuing of the certification, the storage volume certification is issued only when the identification number of one or more memory chips does not coincide with the identification number of a memory chip used in the memory card produced in the past.

19. A data reading and writing method comprising: reading a storage volume certification from a memory card having one or more memory chips and a certification storing unit that stores a storage volume certification including a sum storage volume value of one or more memory chips, and acquiring the sum storage volume value;
accessing the memory card to acquire a card storage volume value;
comparing the sum storage volume value with the card storage volume value; and
reading and writing data from and into the memory card when the sum storage volume value coincides with the card storage volume value.

20. The data reading and writing method according to claim 19, wherein a digital signature generated using a security key and representing that a license organization certifies the sum storage volume value is added to the storage volume certification, and
wherein in the acquiring of the sum storage volume value, it is verified that the sum storage volume value is certified by the license organization using an open key corresponding to the security key.
